(19) United States
(12) Patent Application Publication
(10) Pub. No.: US 2014/0330722 A1
(43) Pub. Date: Nov. 6, 2014

(54) SYSTEM AND METHOD FOR USING AN ACCOUNT SEQUENCE IDENTIFIER

(71) Applicants: Prasanna Laxminarayanan, San Ramon, CA (US); Jose F. Sheets, San Francisco, CA (US); Glenn L. Powell, Fremont, CA (US)

(72) Inventors: Prasanna Laxminarayanan, San Ramon, CA (US); Jose F. Sheets, San Francisco, CA (US); Glenn L. Powell, Fremont, CA (US)

(21) Appl. No.: 14/268,842

(22) Filed: May 2, 2014

Related U.S. Application Data
(60) Provisional application No. 61/818,811, filed on May 2, 2013.
(60) Provisional application No. 61/828,616, filed on May 29, 2013.
(60) Provisional application No. 61/840,387, filed on Jun. 27, 2013.

(51) Int. Cl. G06Q 20/32

(52) U.S. Cl. CPC G06Q 20/3227; G06Q 20/3278
USPC 705/44

(57) ABSTRACT

Embodiments of the invention provide for facilitating a transaction using a communication device associated with a user. Certain embodiments allow for provisioning a communication device for use with an enhanced primary account identifier. The enhanced primary account identifier includes a primary account identifier (PAI) and a primary account identifier sequence number (PSI). The PSI is unique to the communication device and may be de-provisioned if the communication device is lost or stolen. A replacement communication device may be provisioned for use with a newly gemerated unique PSI without having to generate a new PAI.

### CROSS-REFERENCES TO RELATED APPLICATIONS

The present application is a non-provisional application of and claims priority to U.S. Provisional Application No. 61/818,811 titled “ALTERED PAN” filed on May 2, 2013 (Attorney Docket No.: 79900-875044(046400USP1)) and U.S. Provisional Application No. 61/828,616 titled “ALTERED PAN” filed on May 29, 2013 (Attorney Docket No.: 79900-877064(046400USP2)), the entire contents of which are herein incorporated by reference for all purposes.

### BACKGROUND

Contactless transactions involving communication devices have increased in popularity over the last few years. Typically, these communication devices store account information in a secure element residing on the communication device. This account information can include a primary account identifier (PAI) that identifies an account of a user operating the communication device. However, if the user loses his/her communication device or the communication device is stolen, current techniques require invalidation of the PAI and generation of a new PAI. This invalidation step invalidates all other payment devices associated with the PAI, e.g., payment cards, etc. This is inefficient because the user would need to replace all payment devices associated with the PAI.

Embodiments of the invention address this and other problems, both individually and collectively.

### SUMMARY

Embodiments of the invention relate to systems and methods for using an account sequence identifier. More specifically, embodiments of the invention relate to systems and methods for facilitating a transaction using a communication device associated with a user where the communication device is associated with a unique account sequence identifier.

Some aspects of the invention relate to techniques for provisioning a communication device to engage in a transaction using a primary account identifer (PAI) associated with a user account. A unique PAI sequence identifier (PSI) may be generated and associated with the communication device. The PSI can be a sequence that is distinct from both the PAI and an identifier that an issuer would use during a transaction. Additionally, embodiments of the invention can activate and provision the PSI to a communication device when there is a secure element on the communication device and the communication device is near field communication (NFC) capable. Once activated and provisioned, the communication device has the account information so that no card is needed for a transaction. In just one example, the PSI can be appended to the PAI, where the PSI is unique to the communication device. For example, a user's smartphone device can be linked to a PAI (e.g., 5555-2321-2112-3415) followed by a PSI unique to the smartphone (e.g., 89). The combination of the PAI and the PSI can be referred to as an “enhanced PAI”. Thus, the enhanced PAI for the smartphone device would be 5555-2321-2112-3415-89. The advantage of this technique is that if a user loses his/her communication device, a new PAI doesn't need to be issued. Rather, the PSI can be deactivated and a new PSI can be activated and provisioned for the user's replacement device, while maintaining the same PAI. The replacment device can then use the new enhanced PAI for transactions.

For example, a user may wish to register his/her communication device with their PAI associated with their account, for mobile payments. The issuer or payment processor may generate and provision a PSI that is unique to the particular communication device, where the PSI includes at least an identifier unique to the communication device. The PSI, as part of an ehanced PAI, will be loaded into a secure element and record in the payment processor network. The user may use their NFC-equipped, or ther wireless transaction protocol equipped, communication device for mobile payments.

One embodiment of the invention is directed to a method for facilitating a transaction using a communication device associated with a user. The method includes during the transaction, receiving, at a server computer, an authorization request comprising an enhanced primary account identifier (PAI), the enhanced PAI comprising a PAI associated with the user and a PAI sequence identifier (PSI), wherein the PSI is unique to the communication device. The method also includes authorizing the transaction based at least in part on the PSI. The method additionally includes transmitting at least the PAI to an issuer for authorization of the transaction.

Another embodiment of the invention is directed to a server computer comprising a processor, and a computer readable medium coupled to the processor. The computer readable medium comprises code, executable by the processor, for implementing the above-described method.

These and other embodiments of the invention are described in further detail below.

### BRIEF DESCRIPTION OF THE DRAWINGS

FIG. 1A is a block diagram of a traditional payment system, according to an embodiment of the present invention.

FIG. 1B is a block diagram of a payment system incorporating a contactless transaction, according to an embodiment of the present invention.

FIG. 2 is a block diagram of a server computer, according to an embodiment of the present invention.

FIG. 3 is a diagram illustrating multiple payment cards and multiple communication devices belonging to multiple users and associated with the same PAI, according to an embodiment of the present invention.

FIG. 4 is a flow diagram illustrating pre-loading of a PSI, according to an embodiment of the present invention.

FIG. 5 is a flow diagram illustrating registration and activation of a PSI, according to an embodiment of the present invention.

FIG. 6 is a flow diagram illustrating personalization of a PSI, according to an embodiment of the present invention.

FIG. 7 is a flow diagram illustrating transaction processing using a PSI, according to an embodiment of the present invention.

FIG. 8 is a flow diagram illustrating a system for facilitating a transaction using a communication device associated with a user, according to an embodiment of the present invention.

FIG. 9 is a flow diagram illustrating additional details of registration and activation of a PSI, according to an embodiment of the present invention.

FIG. 10 is a flow diagram illustrating personalization of a PSI, according to an embodiment of the present invention.

FIG. 11 is a flow diagram illustrating additional details of transaction processing of a PSI, according to an embodiment of the present invention.

FIG. 12A is a flowchart illustrating an exemplary method for facilitating a transaction using a communication device associated with a user, according to an embodiment of the present invention.

FIG. 12B is a flowchart illustrating a method for provisioning a communication device for use with an enhanced PAI, according to an embodiment of the present invention.

FIG. 12C is a flowchart illustrating a method for initiating a transaction using a communication device associated with a user, according to an embodiment of the present invention.

FIG. 13 is a diagram of a computer apparatus, according to an example embodiment.

### DETAILED DESCRIPTION

Prior to discussing the specific embodiments of the invention, a further description of some terms can be provided for a better understanding of embodiments of the invention.

A “payment device” may include any suitable device capable of making a payment transaction. For example, a payment device can include a card such as a credit card, debit card, charge card, gift card, or any combination thereof. As another example, a payment device can be a communication device that is used to conduct a payment transaction.

A “payment processing network” (e.g., VisaNet™) may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™ in particular, includes a VIP system (Visa Integrated Payments system) which processes authorization requests and a Base II system which performs clearing and settlement services.

A “server computer” can be a powerful computer or a cluster of computers. For example, the server computer can be a large mainframe, a minicomputer cluster, or a group of servers functioning as a unit. In one example, the server computer may be a database server coupled to a Web server.

An “access device” can be any suitable device configured to process payment transactions. For example, an access device (e.g., a point-of-sale (POS) terminal, etc.) can be used to process payment transactions such as credit card or debit card transactions, or electronic settlement transactions, and may have optical, electrical, or magnetic readers for reading data from other portable communication devices such as smart cards, keychain device, cell phones, payment cards, security cards, access cards, and the like.

An “acquirer” can be a business entity (e.g., a commercial bank) that typically has a business relationship with a merchant. An acquirer may receive some or all of the transactions from that merchant.

An “issuer” can be a business entity which issues a payment account that can be used to conduct transactions. Typically, an issuer is a financial institution.

An “account holder” can be user who is authorized to conduct transactions with a payment account. The account holder can be, for example, the account owner of the account associated with a payment device, or an individual who is authorized to use the account on behalf of the account owner. The terms “account holder” and “user” may be used interchangeably in the following description.

A “communication device,” as described herein, can be any electronic communication device that can execute and/or support electronic communications including, but not limited to, payment transactions. Some examples include a personal digital assistant (PDA), a smart phone, tablet computer, notebook computer, and the like.

An “authorization request message” may be an electronic message that is sent to request authorization for a transaction. An authorization request message can be sent, for example, to a payment processing network and/or an issuer of a payment device. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCW (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. An authorization response message can be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a issuer bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

As used herein, a “communications channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instance comprise a “secure communication channel,” which may be established in any known manner, including the use of mutual authentication and a session key and establishment of a secure socket layer (SSL) session. However, any method of creating a secure channel may be used. By establishing a secure channel, sensitive information related to a payment device (such as account numbers, CVV values, expiration dates, etc.) may be securely transmitted between the two or more entities to facilitate a transaction.

A “digital wallet provider” may include any suitable entity that provides a digital wallet service. A digital wallet provider may provide software applications that store account numbers, account numbers including unique identifiers, or representations of the account numbers (e.g., tokens), on behalf of an account holder to facilitate payments at more than one unrelated merchant, perform person-to-person payments, or load financial value into the digital wallet.

A “primary account identifier” (PAI) can be an identifier associated with a user account. PAIs may be found on a payment device and may have a certain level of internal structure and share a common numbering scheme. PAIs may be allocated in accordance with ISO/IEC 7812. The PAI merely identifies the payment device (e.g., payment card), which is then electronically associated by the issuer with one of its customers and then to the customer's (e.g., user's) designated accounts.

A “PAI sequence identifier” (PSI) can be an additional identifier including the PAI. The PSI may be made up of the PAI in addition to an additional unique sequence. The PSI may be used to identify a particular payment device associated with the PAI. The PSI may be unique to the particular payment device and may be used to differentiate multiple payment devices associated with the same PAI.

A “enhanced PAI” may refer to the combination of the PAI and the PSI.

### I. Exemplary Systems

Embodiments of the invention are directed to provisioning a communication device to use a PSI for a transaction.

A payment processor network, or server computer, can generate and provision a PSI for use with a communication device. The PSI can include an identifier unique to the communication device. As such, multiple users of the same account can use multiple payment cards and/or communication devices for transactions associated with the account. The PSI can identify to the issuer and/or payment processor network which type of payment device (e.g., communication device, payment card, etc.), or which particular payment device (e.g., particular communication device, particular payment card) is being used with the transaction, for example, by using a record database maintained by the issuer and/or payment processor network.

In some embodiments, the PSI and/or PAI can be used to identify and personalize credentials for storing onto the communication device, which may use a tap or contactless payment software application. In some embodiments, the PSI and/or PAI can also be used to complete the transaction, or stop or decline the transaction if both data elements are not present in a transaction message or if the PSI in the transaction message does not match the payment device that the PSI is assigned to.

In some embodiments, an issuer may support processing of transactions using a PSI. For example, processing a transaction using PSI may affect the authorization message field, risk system adjustments, implementing an authentication option, and a coded transaction may not carry issuer specific data. The issuer may adapt their procedures and/or systems to recognize the PSI.

In some embodiments, a secure element and a payment application (e.g., software application) may be provided onto a communication device when the communication device is manufactured at the original equipment manufacturer (OEM). In some embodiments, the secure element and/or the payment application can be provided to and/or provisioned on the communication device when it is activated.

Embodiments of the invention provide numerous features. One such feature of techniques disclosed herein is that if a user loses his/her communication device, a new PAI doesn't need to be issued. Rather, the PSI can be deactivated and a new PSI can be activated and provisioned for the user's replacement communication device. Embodiments of the invention can also be used when technology for a fully tokenized solution is not yet available. Additionally, embodiments of the invention can be applied to different types of payment cards (e.g., credit card, debit card, prepaid card, etc.). Further, embodiments of the invention can be compatible with multiple types of payment processing networks, payment platforms, and digital wallets. Further, the PSI can allow for a standard payment card or account to be treated as a chip transaction.

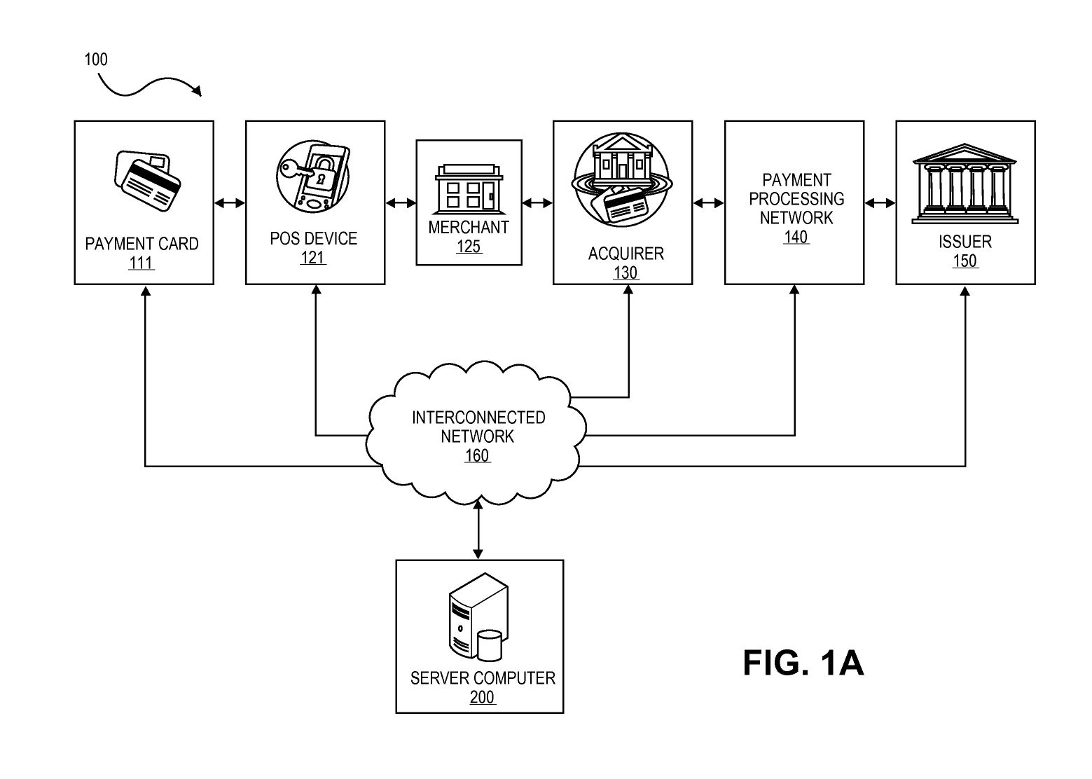

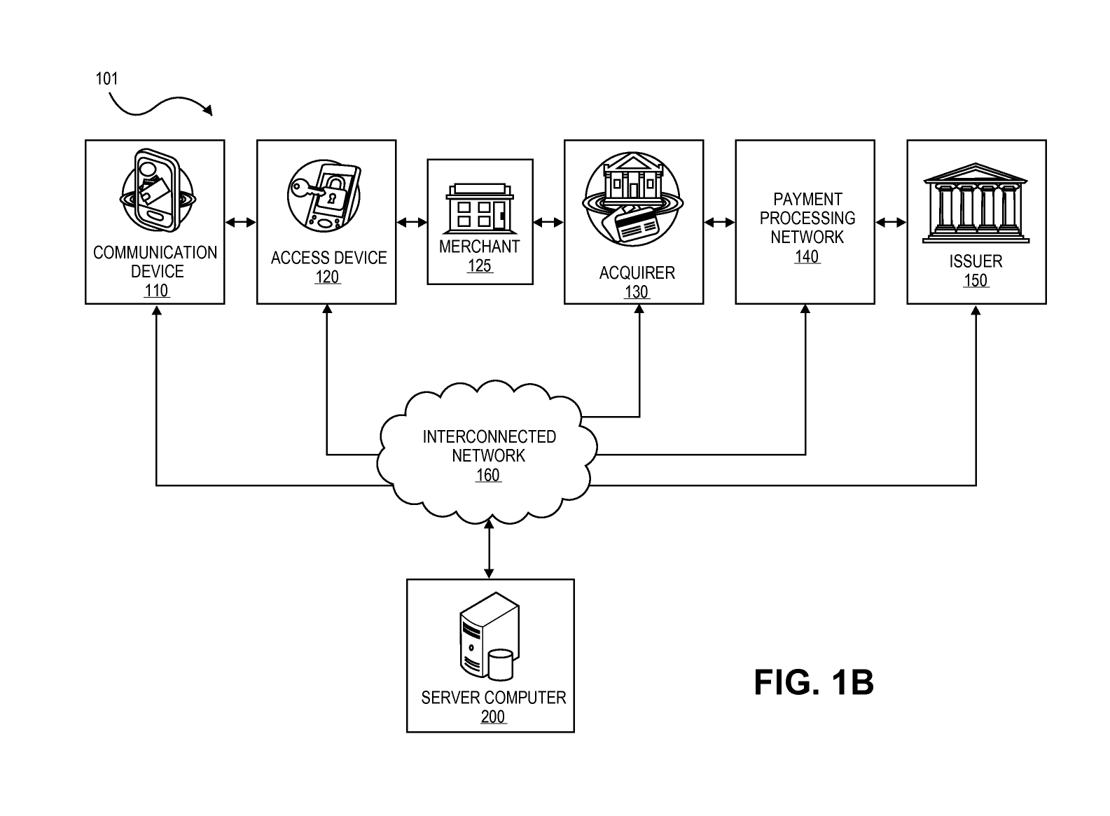

FIG. 1A is a block diagram of a traditional payment system 100, according to one embodiment of the present invention. The system 100 includes a payment card 111, a point-of-sale (POS) device 121, a merchant 125, an acquirer 130, a payment processing network 140, an issuer 150, and an interconnected network 160. The acquirer 130 may further include an acquirer computer (not shown). The payment processing network 140 may include an authorization and settlement server and/or additional servers (not shown) to carry out the various transactions described herein.

In an embodiment, the payment card 111 can be used to initiate a transaction by swiping the payment card 111 at the POS device 121. The payment card may be associated with a PAI of a user account. The payment card 111 may be a credit card, debit card, charge card, gift card, or other payment device and/or any combination thereof.

The POS device 121 is configured to be in electronic communication with the acquirer 130 via a merchant 125. The POS device 121 can be any suitable device configured to process payment transactions such as credit card or debit card transactions. In some embodiments, the POS device 121 is located at and controlled by a merchant. For example, the POS device 121 can be located at a grocery store checkout line. Traditional payment transactions may require that the payment card 111 be physically “swiped” at the POS device 121 to initiate the transaction.

The acquirer 130 (e.g., acquirer bank) includes an acquirer computer (not shown). The acquirer computer can be configured to transfer data (e.g., bank identification number (BIN), etc.) and financial information to the payment processing network 140. In some embodiments, the acquirer 130 does not need to be present in the system 100 for the POS device 121 to transfer the financial and user data to the payment processing network 140. In one non-limiting example, the acquiring bank 130 can additionally check the credentials of the user against a watch list in order to prevent fraud and money laundering schemes, as would be appreciated by one of ordinary skill in the art.

In one embodiment, the payment processing network 140 is VisaNet™, where Visa internal processing (VIP) performs the various payment processing network 140 or multi-lateral switch functions described herein. The payment processing network 140 can include an authorization and settlement server (not shown). The authorization and settlement server (“authorization server”) performs payment authorization functions. The authorization server is further configured to send and receive authorization data to the issuer 150.

In some embodiments, the issuer 150 is a business entity which issues a payment account that can be used to conduct transactions. Typically, an issuer is a financial institution. The issuer 150 is configured to receive the authorization data from the payment processing network 140 (e.g., the authorization server). The issuer 150 receives authentication data from the authorization server and determines if the user is authorized to perform a given financial transaction (e.g., cash deposit/withdrawal, money transfer, balance inquiry) based on whether the user was authenticated by an identification system.

In some embodiments, the POS device 121 may be connected to and communicate with the payment processing network 140 via an interconnected network 160. One example of an interconnected network 160 is the Internet. The payment processing network 140 may inform the POS device 121 when a payment has been successfully processed. In some embodiments, the payment processing network 140 may be connected to and communicate with the access device 120 via the interconnected network 160. The payment processing network 140 may inform the POS device 121 when a payment has been successfully processed which in turn the POS device 121 may complete the transaction involving the payment card 111.

A server computer 200 is also shown in FIG. 1A, and is in operative communication with the interconnected network 160. Details regarding the server computer 200 are provided below.

The interconnected network 160 may comprise one or more of a local area network, a wide area network, a metropolitan area network (MAN), an intranet, the Internet, a Public Land Mobile Network (PLMN), a telephone network, such as the Public Switched Telephone Network (PSTN) or a cellular telephone network (e.g., wireless Global System for Mobile Communications (GSM), wireless Code Division Multiple Access (CDMA), etc.), a VoIP network with mobile and/or fixed locations, a wireline network, or a combination of networks.

In a traditional payment transaction, a user may interact with the POS device 120 (e.g., with a payment device such as the payment card 111 or by entering payment information) to conduct a transaction with the merchant 125. The merchant 125 may be operated by a merchant computer, which may route an authorization request message to the acquirer 130, and eventually to the issuer 150 via the payment processing network 140.

The issuer 150 will then determine if the transaction is authorized (e.g., by checking for fraud and/or sufficient funds or credit). The issuer 150 will then transmit an authorization response message to the access device 120 via the payment processing network 140 and the acquirer 130.

At the end of the day, the transaction is cleared and settled between the acquirer 130 and the issuer 150 by the payment processing network 140.

It can be appreciated that the payment card 111 in the traditional payment transaction may be associated with a PAI identifying the user's account (e.g., bank account). In some embodiments, the payment card 111 may be associated with a PSI that includes an identifier identifying the particular payment card 111. If multiple payment cards 111 are associated with the same user account, each payment card 111 may have a different PSI, wherein the PAI is the same for each card and the PSI is unique to the payment card 111.

FIG. 1B is a block diagram of a payment system 101 incorporating a contactless transaction. The system 101 is similar to system 100 of FIG. 1A, with the exception that the transaction is initiated using a communication device 110 that interfaces with an access device 120. The system 101 includes a communication device 110, an access device 120, a merchant 125, an acquirer 130, a payment processing network 140, an issuer 150, and an interconnected network 160. Reference numerals with similar numbering as FIG. 1A refers to a similar entity or components, and thus a detailed description of which need not be repeated. FIG. 1B is similar to FIG. 1 except that a communication device 110 interfaces with an access device 120 to initiate the transaction.

In an embodiment, a payment device such as communication device 110 is in electronic communication with the access device 120. The communication device 110 can be a personal digital assistant (PDA), a smart phone, tablet computer, notebook computer, or the like, that can execute and/or support payment transactions with a payment system 100. A communication device 110 can be used in conjunction with or in place of a payment card, such as a credit card, debit card, charge card, gift card, or other payment device and/or any combination thereof. The combination of a payment card (e.g., credit card) and the communication device 110 (e.g., smart phone) can be referred to as the communication device 110 for illustrative purposes. In other embodiments, the communication device 110 may be used in conjunction with transactions of currency or points (e.g., points accumulated in a particular software application). In further embodiments, the communication device 110 may be a wireless device, a contactless device, a magnetic device, or other type of payment device. In some embodiments, the communication device 110 includes software (e.g., application) and/or hardware to perform the various payment transactions.

The access device 120 is configured to be in electronic communication with the acquirer 130 via a merchant 125. In one embodiment, the access device 120 is a point-of-sale (POS) device. Alternatively, the access device 120 can be any suitable device configured to process payment transactions such as credit card or debit card transactions, or electronic settlement transactions, and may have optical, electrical, or magnetic readers for reading data from portable electronic communication devices such as smart cards, keychain device, cell phones, payment cards, security cards, access cards, and the like. In some embodiments, the access device 120 is located at and controlled by a merchant 125. For example, the access device 120 can be a POS device at a grocery store checkout line. In other embodiments, the access device 120 could be a client computer or a mobile phone in the event that the user is conducting a remote transaction.

In a typical payment transaction in embodiments of the invention, a user may interact with the access device 120 (e.g., with a payment device such as a payment card or communications device, or by entering payment information) to conduct a transaction with the merchant 125. The merchant 125 may be operated by a merchant computer, which may route an authorization request message to the acquirer 130, and eventually to the issuer 150 via the payment processing network 140. In other embodiments, the user may simply interact with the communication device 110 to conduct a transaction with the merchant 125, e.g., online purchases.

Typically, for contactless transactions, the PAI identifying the user's account (or a representation of the PAI) is stored within a secure element residing on the communication device 110. A software application (e.g., a digital wallet application) running on the communication device 110 may be used to access the PAI stored within the secure element and use it to initiate a transaction with the access device 120. However, in existing solutions, if the communication device 110 is lost or stolen by a fraudster, the PAI associated with the user account must be deactivated to prevent fraudulent transactions by the lost or stolen or communication device 110. This tends to be tedious and ineffective, because other communication devices or payment cards associated with the PAI must also be replaced since a new PAI for the user's account has been generated. Embodiments of the invention address this and other problems, both individually and collectively.

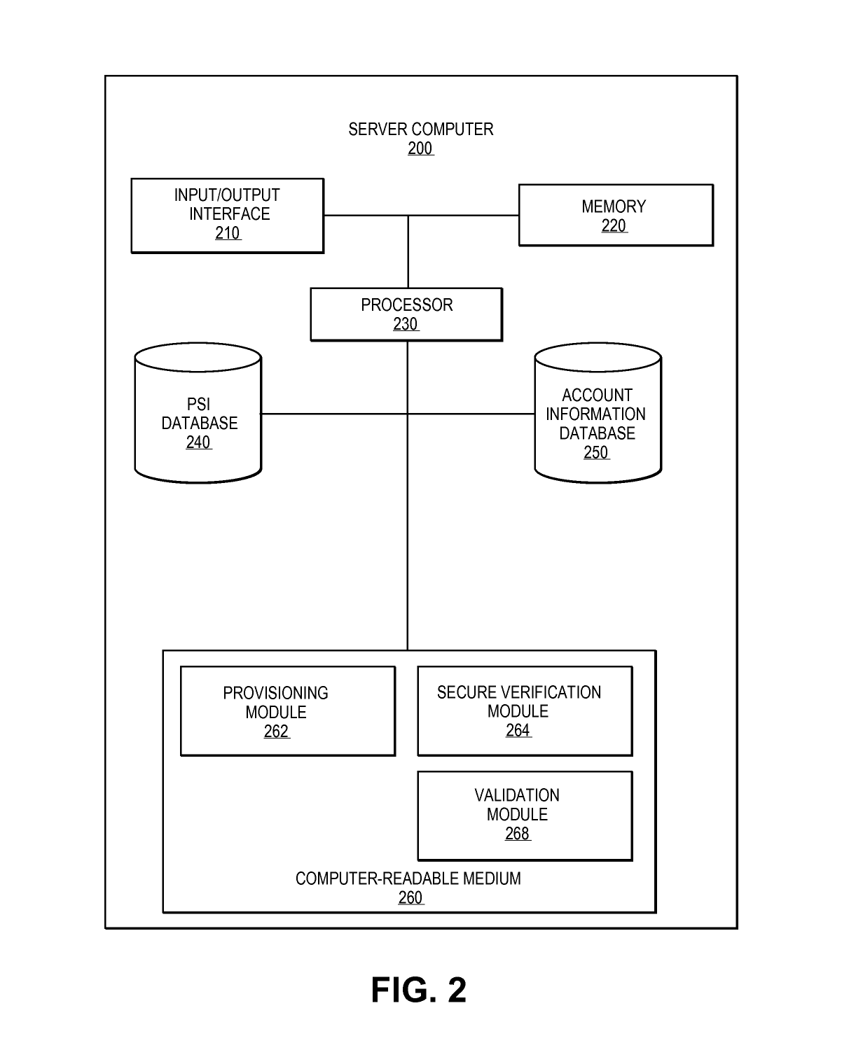

FIG. 2 is a block diagram of a server computer 200, according to an embodiment of the present invention. Server computer 200 includes an input/output interface 210, a memory 220, a processor 230, a PSI database 240, an account information database 250, and a computer-readable medium 260. In some embodiments, the server computer may reside within the interconnected network 160 (FIG. 1A). In other embodiments, the server computer may reside within the payment processor network 140 (FIG. 1A).

The input/output (I/O) interface 210 is configured to receive and transmit data. For example, the I/O interface 210 may receive an authorization request message from the acquirer 130 (FIG. 1A). The I/O interface 210 may also be used for direct interaction with the server computer 200. The I/O interface 210 may accept input from an input device such as, but not limited to, a keyboard, keypad, or mouse. Further, the I/O interface 210 may display output on a display device.

Memory 220 may be any magnetic, electronic, or optical memory. It can be appreciated that memory 220 may include any number of memory modules, that may comprise any suitable volatile or non-volatile memory devices. An example of memory 220 may be dynamic random access memory (DRAM).

Processor 230 may be any general-purpose processor operable to carry out instructions on the server computer 200. The processor 230 is coupled to other units of the server computer 200 including input/output interface 210, memory 220, offers database 240, account information database 250, and computer-readable medium 260.

PSI database 240 is configured to store information about generated PSIs and the communication devices 110 (FIG. 1B) and/or payment cards that correspond to the generated PSIs. The information about the generated PSIs and corresponding communication devices 110 (FIG. 1B) may be stored within the PSI database 240 prior to a transaction taking place. The server computer 200 may communicate, via I/O interface 210, with the communication device 110 during activation and registration phases, described in further detail below. During these phases, the server computer 200 may generate a PSI for a communication device 110 and store the corresponding information within the PSI database 240. The PSI database 240 may be updated any time a new PSI is generated or a PSI already associated with a communication device 110 (FIG. 1B) is updated. In some embodiments, the PSI database 240 may include a one-to-one mapping between a PSI and an identifying attribute of the communication device 110. The identifying attribute can include, but is not limited to, serial number, IMEI number (International Mobile Station Equipment Identity), IMSI number (International Mobile Subscriber Identity) a unique software or network identifier, phone number, etc.

The account information database 250 is configured to store information about a user account. The user account may be associated with a PAI that identifies the user account. Further, the account information database 250 may also include information about the user associated with the account. For example, the account information database 250 may include age information, gender information, credit score information, risk information, etc. pertaining to the user. The account information database 250 may be queried at the time of PSI registration and activation in order to authenticate the user.

Computer-readable medium 260 may be any magnetic, electronic, optical, or other computer-readable storage medium. Computer-readable storage medium 260 includes provisioning module 262, secure verification module 264, and validation module 268. Computer-readable storage medium 260 may comprise any combination of volatile and/or non-volatile memory such as, for example, buffer memory, RAM, DRAM, ROM, flash, or any other suitable memory device, alone or in combination with other data storage devices.

Provisioning module 262 is configured to provision a communication device 110 (FIG. 1B) for use with a PSI. Provisioning the communication device 110 (FIG. 1B) may also include registration and activation of the communication device 110 (FIG. 1B) with the server computer 200. The provisioning module 262 may work in conjunction with the secure validation module 264 (described below) at the time of provisioning the communication device 110 (FIG. 1B). Upon completing activation and registration (described in further detail below), the provisioning module 262 may generate a PSI to associate with the communication device 110. In some embodiments, the provisioning module 262 may update the PSI database 240 with information pertaining to the PSI, once the PSI is generated. The provisioning module 240 may also interface with the account information database 250 during activation, registration, and generation of the PSI, in order to verify certain account information pertaining to the user account for which the PSI is being linked to.

Secure verification module 264 is configured to authenticate a user during provisioning of the communication device 110 (FIG. 1B) for use with a PSI. The secure verification module 264 may use secure verification techniques, such as 3-D secure, to authenticate the user. For example, when a user attempts to activate and register a communication device 110 (FIG. 1B) for use with a PSI, the provisioning module 262 may interface with the secure verification module 264 to authenticate the user. The secure verification module 264 may initiate a redirection of the request to the issuer 150 (FIG. 1B) to authenticate the user. The issuer 150 (FIG. 1B) may use any kind of authentication method, e.g., password-based authentication, one-time password, two-step authentication, etc., in order to authenticate the user. Upon authenticating that the user of the communication device 110 (FIG. 1B) is in fact who he/she claims to be, the secure verification module 264 may notify the provisioning module 262 that the user is authenticated, and the provisioning module 262 may continue with provisioning the communication device 110 (FIG. 1B) for use with a PSI.

Validation module 268 is configured to validate a PSI received in an authorization request message during the course of a transaction. Upon receiving the PSI, the validation module 268 may query the PSI database 240 to ensure that the PSI is a valid PSI. If the PSI is not a valid PSI, the transaction may be denied. The PSI may be deemed valid if the additional identifier value in the PSI is between a range of values reserved for PSIs associated with communication devices 110 (FIG. 1B). For example, PSI values 51-100 may be reserved for communication devices 110 (FIG. 1B). If the PSI is deemed valid, the validation module 268 may also query the PSI database 240 to verify that the PSI is actually the PSI provisioned for the communication device 110 (FIG. 1B).

It can be appreciated that in some embodiments the server computer 200 may reside within the payment processing network 140 (FIG. 1).

### II. Primary Account Identifier (PAI) and PAI Sequence Identifier

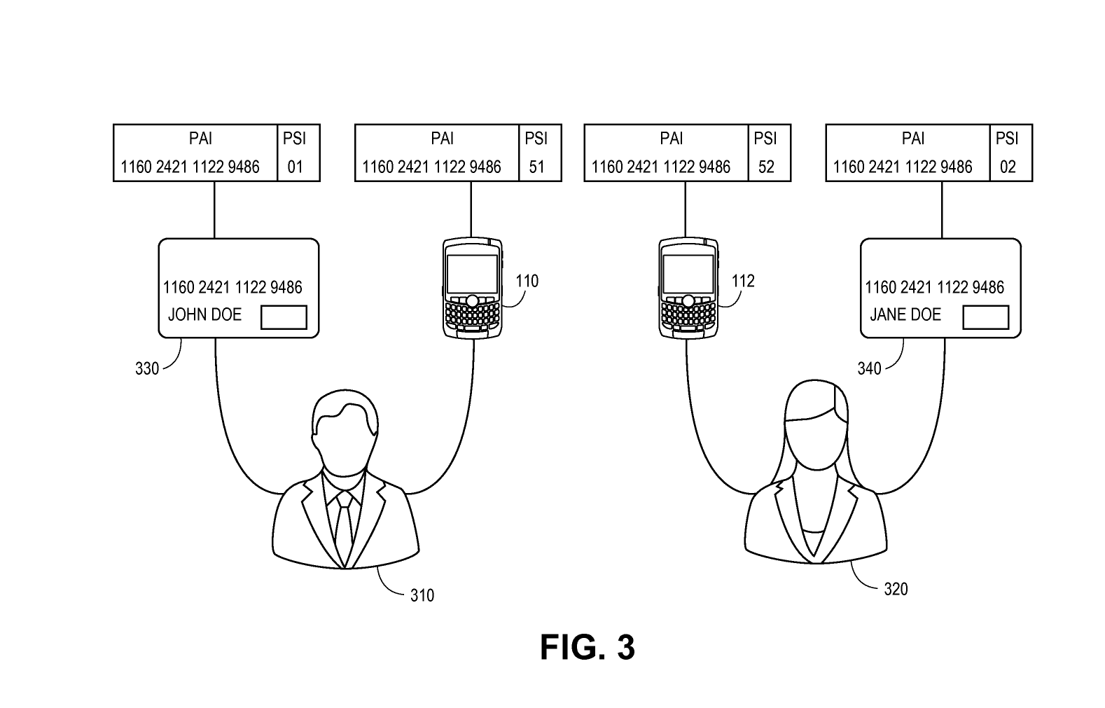

FIG. 3 is a diagram illustrating multiple payment cards 330, 340 and multiple communication devices 110, 112 belonging to multiple users 310, 320 and associated with the same PAI, according to an embodiment of the present invention. In this example, a first user 310 and a second user 320 are authorized users of the same user account, for example, first user 310 and second user 320 may be family members of the same family that share an account. In this case, the user account is identified by the following PAI: “1160 2421 1122 9486”. The first user 310 is in possession of a first payment card 330 and a first communication device 110. The second user 320 is in possession of a second payment card 340 and a second communication device 112. Both the communication devices 110, 112 and both the payment cards 330, 340 are associated with the same PAI (e.g., “1160 2421 1122 9486”). The first payment card 330 and the second payment card 340 may have unique PSI values. The PSI value is unique the payment card 330, 340. For example, the first payment card 330 has a PSI of 01 and the second payment card 340 has a PSI of 02. The PSIs generated for the payment cards 330, 340 may be generated from a range of PSIs reserved for payment cards only. For example, PSIs ranging from 01 to 50 may be reserved for payment cards only. It can be appreciated that while the PSIs shown in the example are two digits, any number of digits or other alphanumeric characters may be used for the PSI.

As described above, embodiments of the invention allow for provisioning a communication device to use a PSI. As shown in the example, the first communication device 110 has a PSI of 51 and the second communication device 112 has a PSI of 52. Together, the combination of the PAI and PSI make up an “enhanced PAI”. The PSIs generated for the communication devices 110, 112 may be generated from a range of PSIs reserved for communication devices only. For example, PSIs ranging from 51 to 99 may be reserved for communication devices only. The PSIs may be used to identify which communication device 110, 112 is initiating the transaction involving the user account. For example, if a PSI of 51 is received in an authorization request, the server computer 200 (FIG. 2) may determine that the first communication device 110 is initiating the transaction, as described above. The advantage of a unique PSI for each communication device 110, 112 is that if a user loses his/her communication device, a new PAI doesn't need to be issued. Rather, the PSI can be deactivated and a new PSI can be activated and provisioned for the user's replacement communication device. It can be appreciated that PSIs for subsequent communication devices provisioned for use with an enhanced PAI may be generated sequentially or arbitrarily. For example, a subsequent communication device could have a PSI of 53, or it could have a PSI of 78.

Details of provisioning the communication devices 110, 112 for use with the PSI, and the enhanced PAI, are described in further detail below.

### III. Preloading

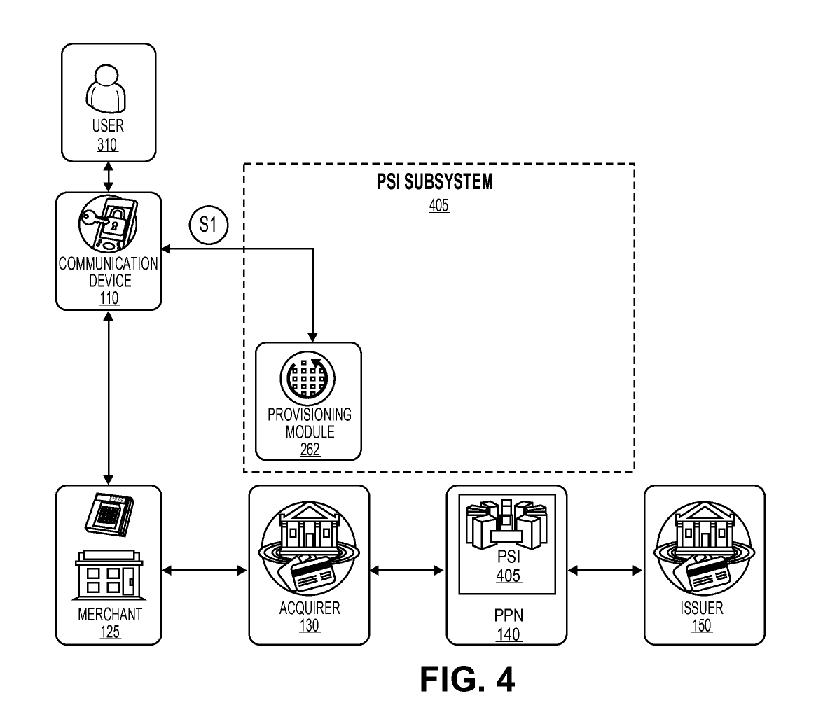

FIG. 4 is a flow diagram illustrating pre-loading of a PSI, according to an embodiment of the present invention. Pre-loading may include a creation of a controlled and secure domain, e.g., the PSI subsystem 405. In some embodiments, a tap or contactless payment application can be loaded onto a secure element within the communication device 110. The tap or contactless payment application can be loaded during assembly or manufacture of the communication device 110. Additionally, a software application (e.g., a digital wallet application) can be downloaded by the user 310 once the user is in possession of the communication device 110. In some embodiments, a key management server (not shown) or a software application can be implemented in PSI subsystem 405, which may be operated by, e.g., an entity in payment processing network 140. During pre-loading, specific keys and payment processor network 140 implementation specific elements may also be pre-loaded onto the communication device 110. The payment processor network 140 may have a working relationship with the manufacturer of the communication device 110 to facilitate this implementation.

At step s1, following pre-loading by the manufacturer or by another entity after manufacture, the communication device 110 may interface with the provisioning module 262 (of server computer 200 (FIG. 2) and/or part of the PSI subsystem 405) to begin the provisioning process of registering and activating the communication device 110 for use with a PSI. At this point, the user may have already provided their PAI from their payment card into a digital wallet application or similar software application running on the communication device 110.

### IV. Registration and Activation

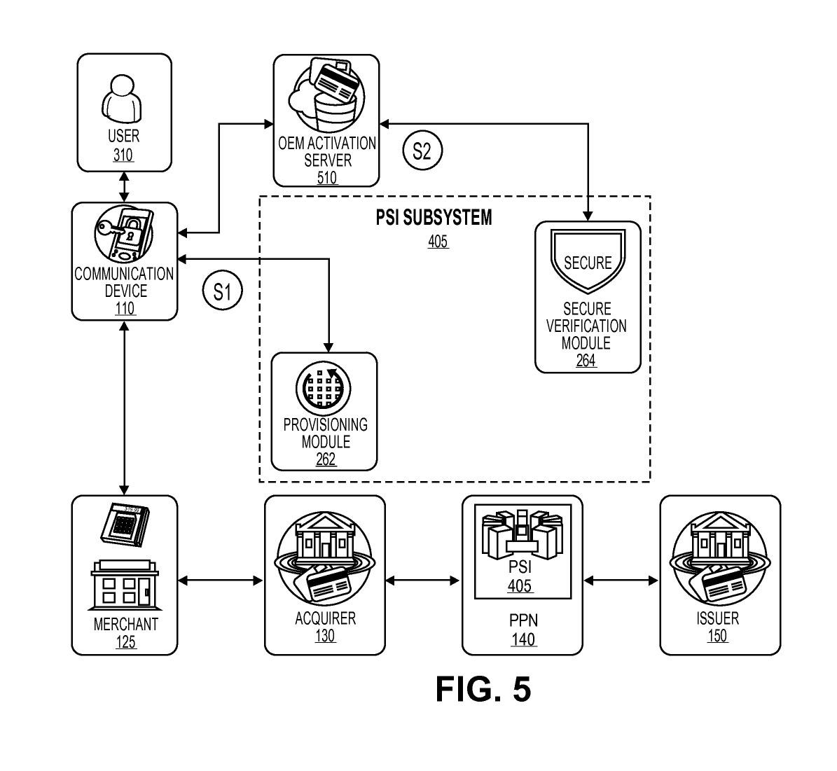

FIG. 5 is a flow diagram illustrating registration and activation of a PSI, according to an embodiment of the present invention. Upon pre-loading of the communication device 110 by the device manufacturer, the user 310 may activate and register his/her communication device 110 for use with a PSI. The OEM activation server 510 may use a merchant plug-in and integrate with a secure verification module 264 to authenticate the user during the registration and activation. The secure verification module 264 may reside within the PSI subsystem 405. In some embodiments, the OEM activation server 510 may reside with a network of a digital wallet provider. In other embodiments, the OEM activation server 510 may reside within the payment processor network 140.

At step s1, as described with respect to FIG. 4, the communication device 110 may interface with the provisioning module 262 to begin the provisioning process of registering and activating the communication device 110 for use with a PSI.

At step s2, the OEM activation server 150 may interface with the secure verification module 264 to authenticate the user 310 prior to allowing registration and activation of the user's 310 communication device 110 for use with a PSI. In some embodiments, the secure verification module 264 may implement 3-D Secure (e.g., Verified by Visa) protocols to carry out the authentication of the user 310.

At the time of the user performing the registration and activation of their communication device 110, the communication device 110 may communicate with the OEM activation server 510. The user may initiate the registration and activation of their communication device 110 by opening a software application (e.g., tap or contactless payment application or digital wallet application) on their communication device 110 and selecting an option for new device registration. It can be appreciated that the OEM activation server 510 may not have all the necessary information that may be required for registration pertaining to the user 310 attempting to register and activate the communication device 110. As such, the OEM activation server 510 may interface with the secure verification module 264 in order to authenticate the user 310 (e.g., cardholder verification).

The secure verification module 264, via PPN 140, may interface with the issuer 150 in order to authenticate the user 310. It can be appreciated that the issuer 150, as the issuer of the user account the user 310 is attempting to enroll the communication device 110 in, may have access to information pertaining the user 310. For example, this information can include personal details about the user 310, such as mother's maiden name, street address, address history, favorite color, etc. The secure verification module 264 may redirect communication from the OEM activation server 510 to the issuer 150. The issuer 150 may then present a challenge question, as described above, or may request a one-time password from the user 310. In some embodiments, the one-time password may be sent to the user's communication device 110 via a text message, e-mail, etc. The secure verification module 264 may notify the issuer 150 that the user 310 is attempting to authenticate, and provide the issuer 150 with the user's 310 payment card information, e.g., PAI, expiration date, CVV2, etc. The issuer 150 may then facilitate a communication to the user's 310 communication device 110, via the secure verification module 264 and OEM activation server 510, requesting that the user 310 answer a challenge question. The challenge question could be generated from one of the pieces of information pertaining to the user 310, e.g., mother's maiden name, street address, address history, favorite color, etc. In some embodiments, a challenge question may not be required as the issuer may be able to authenticate the user without any challenge to the user 310. In some embodiments, instead of a challenge question, the issuer 150 may request that the user 310 enter a one-time password within the application running on the communication device 110 in order to authenticate. It can be appreciated that in some embodiments, the issuer 150 may outsource the authentication to a third-party access control server (ACS).

Once the user has been successfully authenticated by the secure verification module 265 (e.g., by redirecting communication to the issuer 150), the communication device 110 may be activated and registered to use the PSI. Upon successful registration and activation of the communication device 110, the communication device 110 may be personalized with the PSI.

### V. Personalization

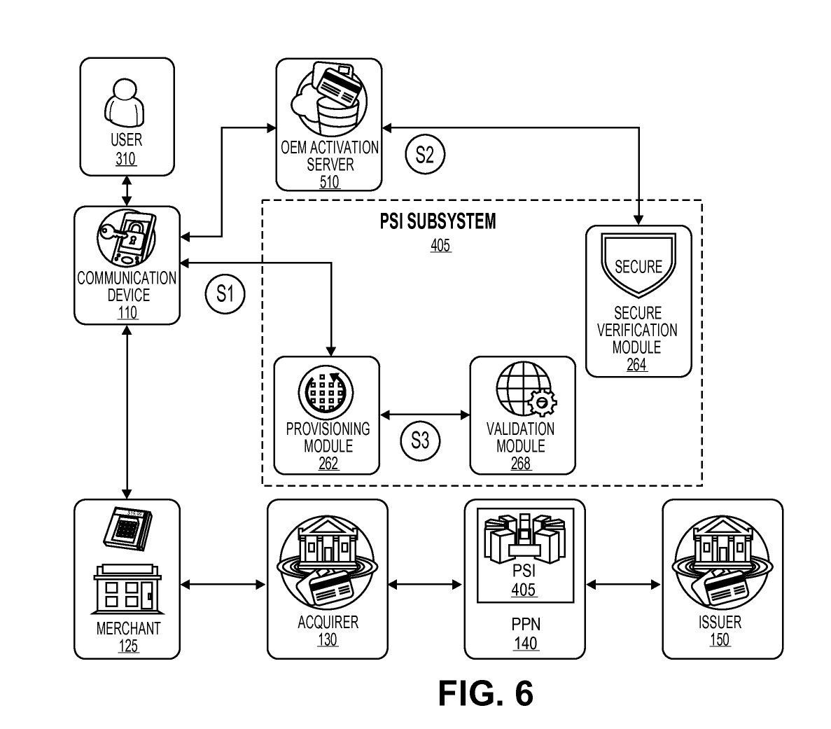

FIG. 6 is a flow diagram illustrating personalization of a PSI, according to an embodiment of the present invention. Personalization of the PSI may include generating a PSI that may be provisioned or loaded onto the communication device 110. In addition to generating the PSI, the personalization step may also include creation of other information or data used for conducting secure tap or contactless (e.g., NFC based) payment transactions. These additional information or data may also be loaded onto the communication device 110.

At step s1, as described with respect to FIG. 4, the communication device 110 may interface with the provisioning module 262 to begin the provisioning process of registering and activating the communication device 110 for use with a PSI.

At step s2, as described with respect to FIG. 5, the OEM activation server 150 may interface with the secure verification module 264 to authenticate the user 310 prior to allowing registration and activation of the user's 310 communication device 110 for use with a PSI.

At step s3, the provisioning module 262 may interface with the validation module 268 in order to personalize the PSI for the communication device 110. Both the provisioning module 262 and the validation module may access the PSI database 240 to determine which PSIs are already in use for the PAI associated with the user's 310 account. The provisioning module 262 may then generate a new PSI to load on to the communication device 110. The PSI may be based on a predefined personalization script implemented by the PPN 140 and PSI subsystem 405. In some embodiments, the personalization script may take into account certain elements such as the PAI and the expiry date of the payment card when generating the PSI. In other embodiments, the PSI may simply be generated in a sequential manner (e.g., incrementing the last generated PSI for a communication device 110 associated with the user's 310 PAI by one, etc.).

Information pertaining to the generated PSI (including the PSI value itself) may then be communicated to the communication device 110, via provisioning module 262. The communication device 110 may then load the PSI onto the secure element within the communication device 110. A software application (e.g., or contactless payment application or digital wallet application) running on the communication device 110 may facilitate the storing of the PSI within the secure element. The software application may also facilitate accessing the PSI stored within the secure element during initiation of a transaction.

It can be appreciated that other aspects of personalization may be stored within the secure element on the communication device 110 consist of, but is not limited to: personal user 310 information, cardholder data, card credentials, application cryptogram, transaction calendar, unique cryptogram generation keys, etc.

As described above, the PSIs generated for the communication device 110 may be generated from a range of PSIs reserved for communication devices only. For example, PSIs ranging from 51 to 99 may be reserved for communication devices only. The PSIs may be used to identify whether a communication device or a payment card is initiating the transaction, and or which particular communication device 110 or particular payment card is initiating the transaction involving the user account. For example, if a PSI of 51 is received in an authorization request, the server computer 200 (FIG. 2) may determine that a communication device, not a payment card, is initiating the transaction. In some embodiments, server computer 200 may determine that the first communication device 110 is initiating the transaction, as described above. An exemplary enhanced PAI including a generated PSI may be “1160 2421 1122 9486-51”, where “1160 2421 1122 9486” is the PAI and “51” is the PSI.

After the personalization of the PSI on the communication device 110, the communication device 110 may be ready to initiate a transaction with a merchant 125 using the PSI stored within the communication device 110.

### VI. Transaction Processing

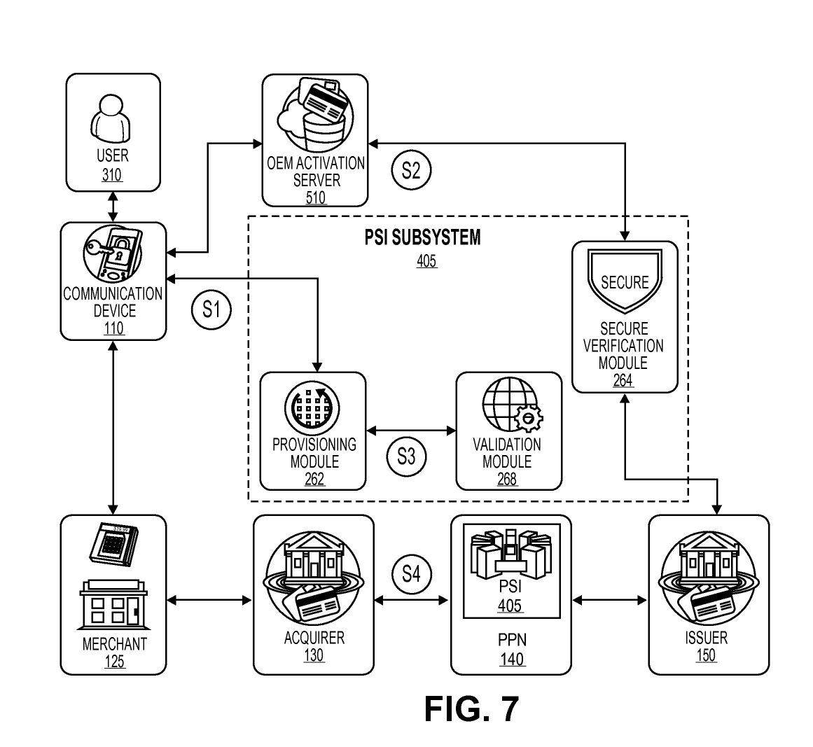

FIG. 7 is a flow diagram illustrating transaction processing using a PSI, according to an embodiment of the present invention. The transaction may be a tap or contactless transaction initiated by the communication device 110. During the transaction, the PPN 140 may validate the PSI provided from the communication device 110, before sending the transaction or authorization request message to the issuer 150 for transaction authorization.

At step s1, as described with respect to FIG. 4, the communication device 110 may interface with the provisioning module 262 to begin the provisioning process of registering and activating the communication device 110 for use with a PSI.

At step s2, as described with respect to FIG. 5, the OEM activation server 150 may interface with the secure verification module 264 to authenticate the user 310 prior to allowing registration and activation of the user's 310 communication device 110 for use with a PSI.

At step s3, the provisioning module 262 may interface with the validation module 268 in order to personalize the PSI for the communication device 110.

When the user 310 is ready to initiate a transaction with the merchant 125, the user 310 may execute the software application (e.g., tap or contactless payment application or digital wallet application) on their communication device. The user 310 may then indicate his/her desire to initiate the transaction. The user 310 may initiate the transaction by waving their communication device 110 near an access device located at the merchant 125 (e.g., in the case of an NFC transaction), or may connect to the access device using any other wireless protocol. Upon initiating the transaction, the merchant 125 may send an authorization request message to the merchant acquirer 130.

At step s4, the acquirer 130, upon receiving an authorization request message from the merchant 125, may communicate with the PPN 140 to request authorization of the transaction. The authorization request message may include the the PAI and the PSI. Upon receiving the authorization request message, the PPN 140 and PSI subsystem 405 may validate the enhanced PAI. The validation module 268 may analyze the received PSI value to determine what type of payment device (e.g., payment card or communication device) is being used to conduct the transaction. For example, if the received PSI value is from a set of PSI values reserved for communication devices, the validation module 268 may determine that the transaction was initiated by a communication device 110. Additionally, the authorization request message may contain other data elements that indicate the transaction was initiated from the communication device 110. The validation module 268 may compare the received PSI value to other data elements in the authorization request message to ensure that a communication device 110 was used to initiate the transaction. For example, if the received PSI value indicates a communication device 110 initiated transaction and data elements from the authorization request message indicate a payment card initiated transaction, the PPN 140 may deny the transaction, or vice versa.

Upon confirming that the transaction was initiated by the communication device 110, the validation module 268 may access the PSI database 240 to verify that the received PSI value is the PSI value that was actually generated for the specific communication device 110 at the time of registration and activation. As described above, the PSI database 240 may contain a mapping of PSI values to the specific communication devices 110 for which they were generated. The validation module 268 may ensure that the mapping indicates the proper communication device 110 and that the mapping is still valid. That is, the validation module 268 may ensure that the PSI value is not a deactivated PSI value (e.g., due to loss or theft of a communication device), and/or that the PSI value corresponds to a communication device rather than a payment card.

Upon determining that the mapping of the PSI value to the specific communication device 110 is correct, the validation module 140 may indicate that the transaction should be authorized. The PPN 140, after verifying other aspects of a traditional transaction authorization, may authorize the transaction and the transaction flow may follow a traditional transaction flow thereafter. That is, the PPN 140 may then send the authorization request message to the issuer 150 for authorization by the issuer 150.

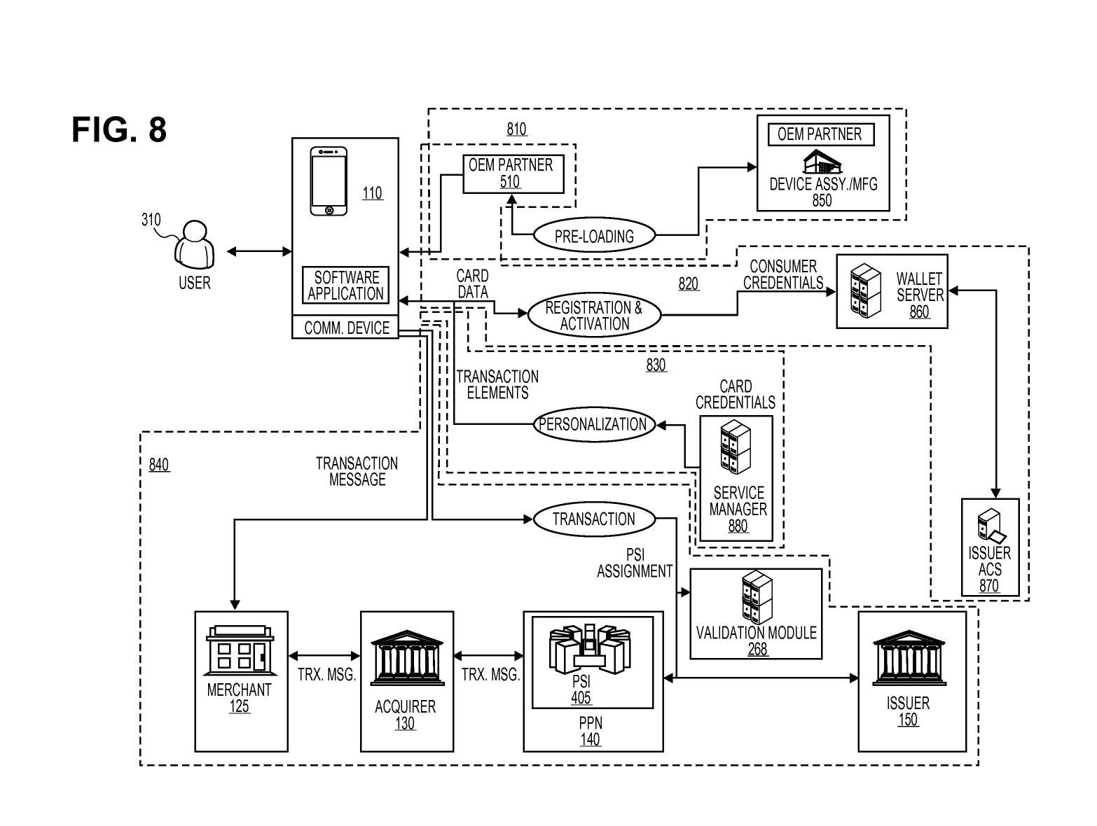

FIG. 8 is a flow diagram illustrating a system for facilitating a transaction using a communication device associated with a user, according to an embodiment of the present invention. The flow diagram in FIG. 8 provides a comprehensive overview of the preloading (described with respect to FIG. 4), registration and activation (described with respect to FIG. 5), personalization (described with respect with respect to FIG. 6), and transaction processing (described with respect to FIG. 7) steps.

The flow in box 810 describes preloading of the communication device 110. As described with respect to FIG. 4, the communication device 110 may be provided by the OEM partner 510 during device assembly and/or manufacturing (box 850).

The flow in box 820 describes registration and activation of the communication device 110. As described with respect to FIG. 5, the communication device 110 may relay payment card data, including the PAI, as inputted by the user 310 into the software application. The payment card data along with the consumer credentials may be sent from the communication device 110 to the wallet server 860. The wallet server 860 may be implemented by a digital wallet provider affiliated with the software application. The payment data and consumer credentials may also be relayed to an issuer ACS 870 for secure validation and authentication of the user 310. Upon authentication of the user 310, the communication device may be registered with the wallet server 860 and PSI subsystem 405.

The flow in box 830 describes personalization of the PSI for storage within the communication device 110. As described with respect to FIG. 6, after registration and activation of the communication device 110, the PSI may be personalized for storage on the communication device 110. The PSI may be personalized by a service manager 880 residing within the payment processor network 140 and/or PSI subsystem 405, or other entities. The service manager 880 may generate the PSI based on various elements described above with respect to FIG. 5. In some embodiments, the service manager 880 may include the validation module 268 (FIG. 2). The generated PSI may be stored within a secure element residing on the communication device 110.

The flow in box 840 describes transaction processing. As described with respect to FIG. 7, upon personalization of the PSI for storage of the communication device, the communication device 110 may initiate a transaction using the software application. The software application may access the secure element and the PSI value stored within the secure element or some other memory. Upon initiation of a contactless transaction using the communication device 110 at the merchant 125, the merchant 125 may send a transaction authorization message to the acquirer 130 of PPN 140. In some embodiments, the acquirer may relay the transaction message to the PPN 140. The PPN 140 may validate the PSI with the validation module 268. The validation module 268 may validate the PSI by accessing the PSI database 240 and verifying the mapping of the PSI to the communication device 110. After the PSI is verified, the transaction may continue as a normal transaction would.

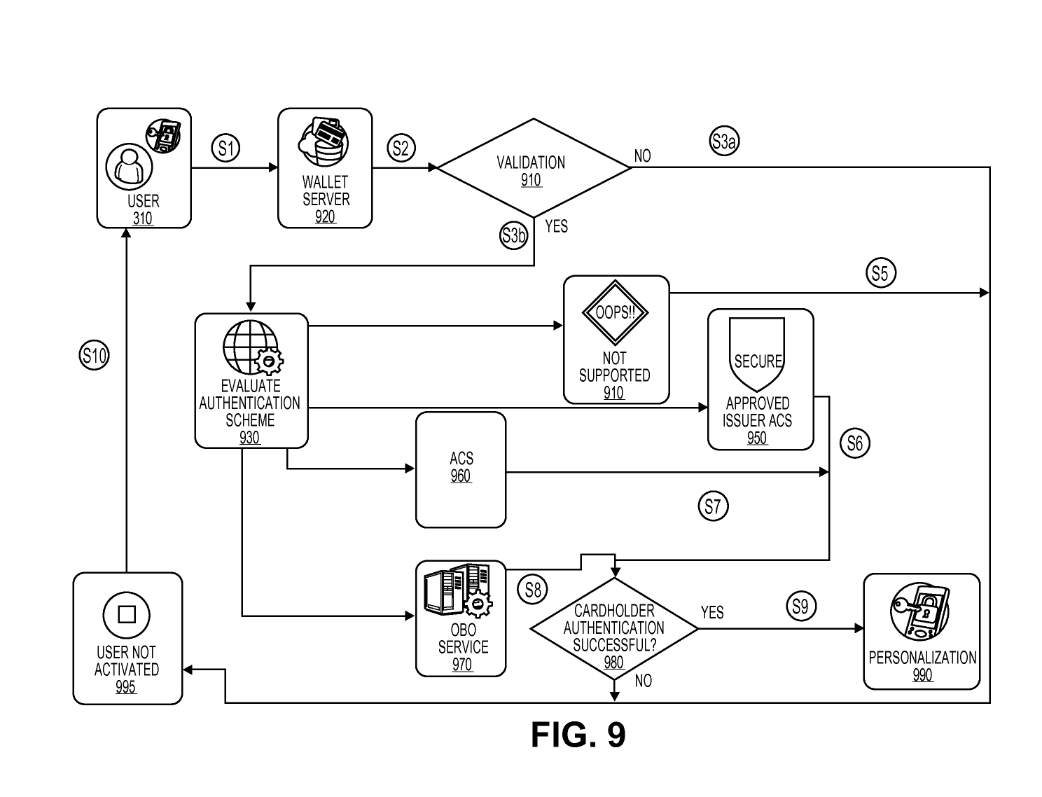

FIG. 9 is a flow diagram illustrating additional details of registration and activation of a PSI, according to an embodiment of the present invention. At step s1, the user 310 interacts with his/her communication device 110 (FIG. 1A). The communication device 110 (FIG. 1A) may already have been preloaded for use with a PSI. The communication deice 110 (FIG. 1A) communicates with the wallet server 920. The wallet server receives the request to register and activate the communication device 310 with the wallet server 920 and for use with a PSI. The wallet server may determine whether validation (block 910) of the user 310 of the communication device 110 (FIG. 1A) is validated with the wallet server 920 (e.g., the user's credentials provided to the digital wallet provider are correct). If the user 310 is not validated (step s3a), it may be determined that the consumer should not be activated (block 995) and an error message may be returned the user 310 via the communication device 110 (FIG. 1A). It is possible that the user 310 could not be validated because the user's account is not in good standing, or other potential reasons.

If the user is validated (step s3b), the authentication scheme to be used to authenticate the user 310 is evaluated (block 930). If a suitable authentication scheme is not supported (step s5), the user may not be authorized and/or the communication device may not be activated (block 995). The authentication scheme may not be supported because the issuer may have opted out or the product is unsupported, etc. Otherwise, an approved issuer ACS (e.g., 3D Secure) (block 950) (step s6), unapproved issuer ACS (block 960) (step s7), or OBO risk based verification service (block 970) (step s8) may be used to authenticate the user. A determination is then made if user 310 authentication is successful (block 980). If the user 310 cannot be successfully authenticated using one of the mentioned methods, the communication device of the user (e.g., consumer) may not be activated (block 995) for payment purposes. If the user 310 is successfully authenticated, the communication device 110 (FIG. 1A) may successfully register and activate with the PSI subsystem 405 (FIG. 4) and the PSI may be personalized (block 990) for storage on the communication device 110 (FIG. 1A).

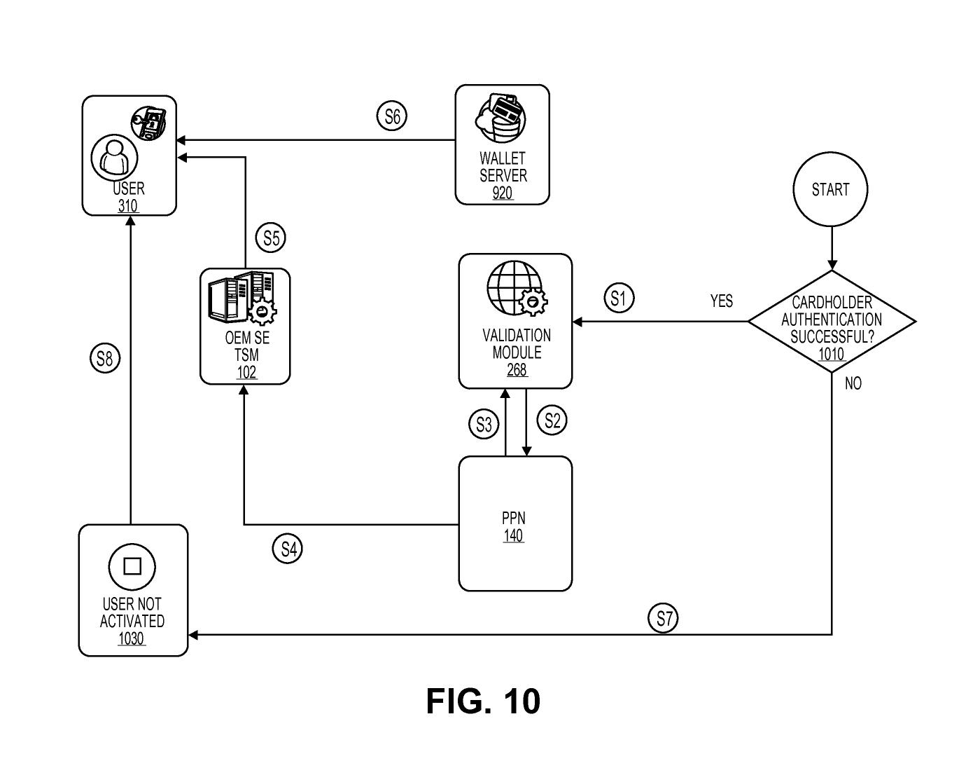

FIG. 10 is a flow diagram illustrating personalization of a PSI, according to an embodiment of the present invention. A determination may be made whether cardholder authentication was successful (block 1010). If authentication was not successful (step s7), a PSI may not be personalized and loaded on to the communication device 110 (FIG. 1A) and the user may not be activated (block 1030). If cardholder authentication is successful (step s1), the process of generating a PSI may begin. The validation module 268 may interface with the PPN 140 (step s2) and the PSI database 240 (FIG. 2) in order to personalize the PSI. The PPN 140 may respond (step s3) with data pertaining to the user 310 that may be used to personalize the PSI. Additionally, the PSI database 240 (FIG. 2) may provide a mapping of existing PSIs to existing communication devices, as to ensure that a new unused PSI may be generated. In step s4, the PPN 140 may relay a personalization script to an OEM secure element (SE) trusted service manager (TSM) 102. The personalization script may incorporate information relayed in steps s2 and s3. In step s5, the OEM SE TSM server may personalize the PSI and store the PSI along with the enhanced PAI within the communication device 110 (FIG. 1A) of the user 310. The personalized PSI and enhanced PAI may be stored, for example, within a secure element residing on the communication device 110 (FIG. 1A).

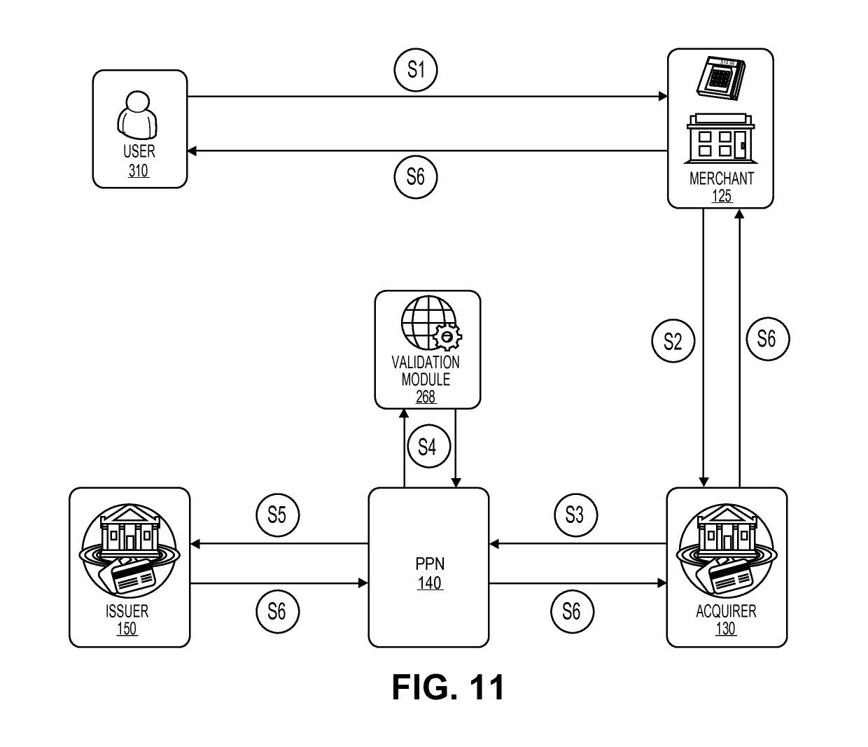

FIG. 11 is a flow diagram illustrating additional details of transaction processing of a PSI, according to an embodiment of the present invention. At step s1, the user 310 may use his/her communication device 110 (FIG. 1A) to initiate a contactless transaction at a merchant 125 location (e.g., at a POS terminal or access device). The communication device 110 (FIG. 1A) may send a transaction message to a NFC, or other tap or contactless protocol based POS or access device at the merchant 125 location. The transaction message may include the enhanced PAI and the PSI. In some embodiments, the NFC capability on the communication device 110 (FIG. 1A) is disabled by default to avoid NFC sniffing. The NFC capability may be enabled when the user 310 unlocks the NFC capabilities, e.g., by touching a “Pay Now” button on the software application running on the communication device 110 (FIG. 1A). In some embodiments, a passcode may be used on the communication device 110 (FIG. 1A) for additional security.

At step s2, the POS terminal or access device can send an authorization request message with other payment information and the enhanced PAI (which may include the PSI) to the acquirer 130 for processing.

At step s3, the acquirer 130 may send the authorization request message to the PPN 140 for routing and processing.

At step s4, the PPN 140 may recognize the enhanced PAI in the authorization request message. The PPN 140 may then use the validation module 268 within the PSI subsystem 405 (FIG. 4) to validate the PSI. As described above, the PSI may be validated by accessing the PSI database 240 and validating the PSI based on information stored within the PSI database 240. The PPN 140 may validate the PSI and verify activation of the communication device 110 (FIG. 1A).

At step s5, upon successful validation, the PPN 140 may route the authorization request message to the issuer for authorization with appropriate indicators and values.

At step s6, upon authorization from the issuer, an authorization response message from the issuer may be passed back through the PPN 140 to the acquirer 130 and on to the merchant 125. The user 310 may then receive a transaction completion message from the merchant.

It can be appreciated that advantages of the techniques described herein include new technology, an improved customer experience, immediate use, a payment card equivalent, and improved performance.

The new technology can enable communication devices for NFC based mobile tap or contactless transactions. The user or user account credentials can be, for example, securely stored and managed in the secure element within the communication device.

The improved user experience can involve an intuitive user experience for activation and usage. The user account may not need to be reissued for a lost or stolen communication device. For example, the system can allow the communication device to be canceled without also canceling the user's account. The system can provide improved registration, activation, and transaction processing using software application (e.g., applet).

The system can also be available for immediate use after registration and activation. For example, the communication device can be available for use at a POS terminal accepting NFC (or other protocol) communications, and support credit and debit payments.

The use of the communication device at a POS terminal can carry similar benefits and/or acceptance as a physical plastic payment card. In some embodiments, transactions performed with the communication device can have card present designation such that the transaction is treated as a card present transaction, e.g., to qualify for card present rates and other benefits.

### VII. Exemplary Methods

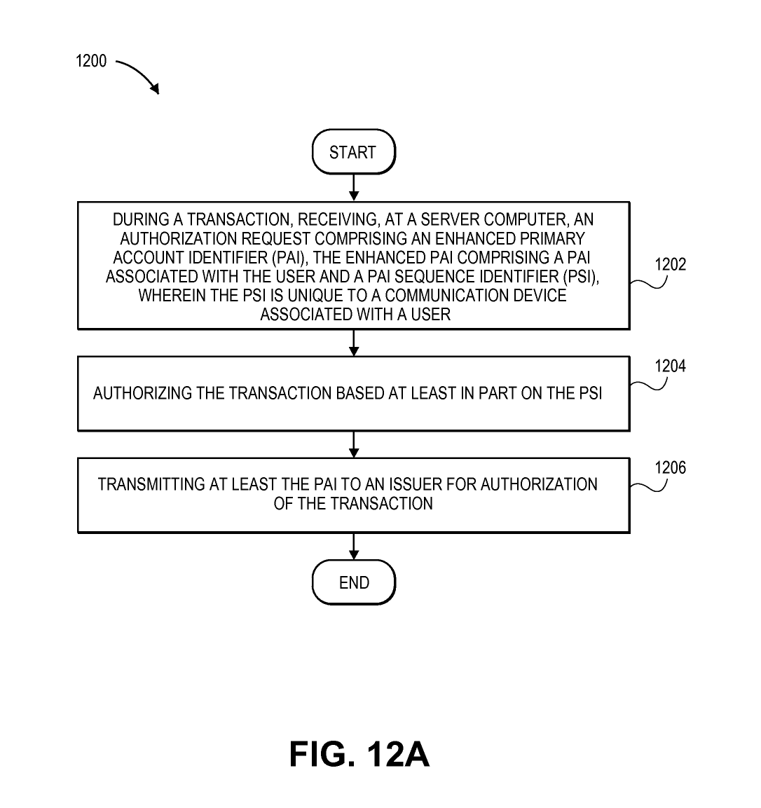

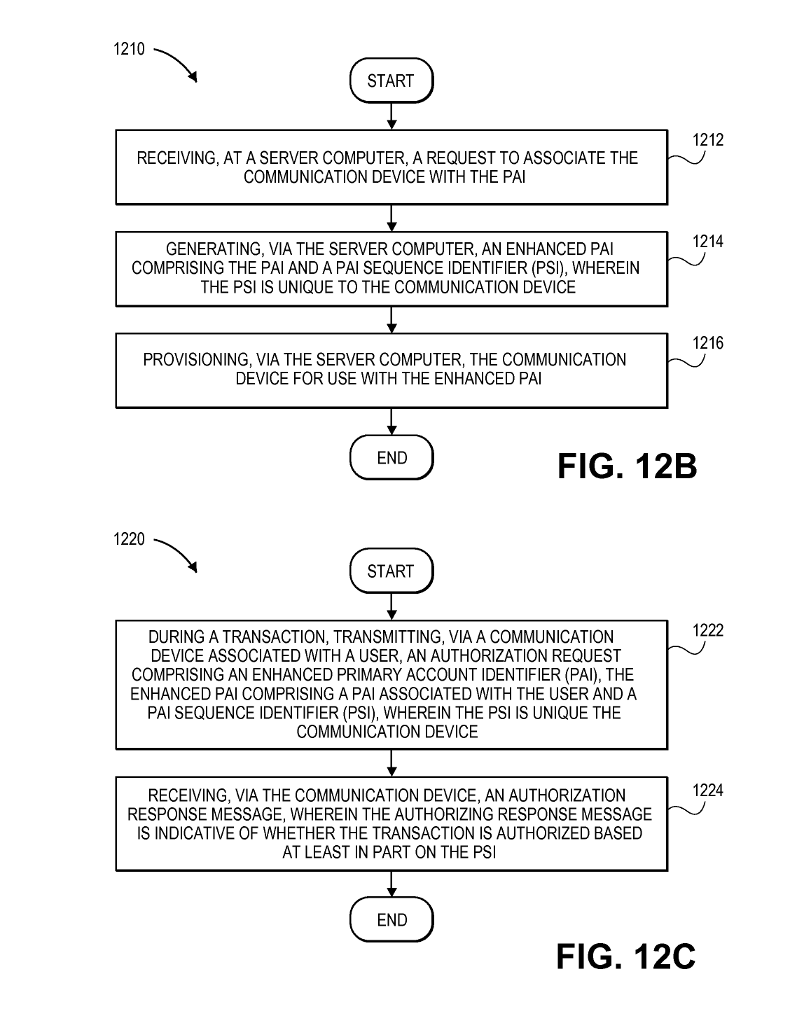

FIG. 12A is a flowchart illustrating a method 1200 for facilitating a transaction using a communication device associated with a user. The method 1200 is performed by processing logic that may comprise hardware (circuitry, dedicated logic, etc.), software (such as is run on a general purpose computing system or a dedicated machine), firmware (embedded software), or any combination thereof. In certain embodiments, the method 1200 is performed by the server computer 200 or the payment processing network 140 of FIG. 1A.

The method 1200 may begin when a user initiates a transaction using his or her communication device. Upon the user initiating the transaction, the server computer may receive, an authorization request comprising an enhanced PAI, the enhanced PAI including a PAI associated with the user and a PAI sequence identifier (PSI) (Step 1202). The PSI may be unique to the communication device associated with the user.

After the server computer receives the authorization request message, the server computer may authorize the transaction based at least in part on the PSI (Step 1204). The PSI may have a one-to-one mapping with the communication device.

After the server computer authorizes the transaction based at least in part on the PSI, the server computer may transmit at least the PAI to an issuer for authorization of the transaction (Step 1206).

In some embodiments, the server computer may receive a request to associate the communication device with the PAI. In some embodiments, the server computer may generate an enhanced PAI comprising the PAI and a PAI sequence identifier (PSI), wherein the PSI is unique to the communication device. In some embodiments, the server computer may provision the communication device for use with the enhanced PAI.

In some embodiments, prior to provisioning the communication device for use with the enhanced PAI, the server computer may verify an identity of the user of the communication device with the issuer via a secure verification protocol.

In some embodiments, the server computer may determine, via the server computer, that the authorization request is for a transaction initiated by the communication device based at least in part on the PSI.

In some embodiments, the communication device is a first communication device, the enhanced PAI is a first enhanced PAI, and the PSI is a first PSI. The server computer may generate a second enhanced PAI comprising the PAI and a second PSI, wherein the second PSI is unique to a second communication device and is different than the first PSI (e.g., when the first communication device is reported as stolen or lost). The server computer may then provision the second communication device for use with the second enhanced PAI.

In some embodiments, upon a request from the user of the first communication device, the server computer may de-provision, via the server computer, the first communication device for use with the first enhanced PAI (e.g., when the first communication device is reported as stolen or lost).

In some embodiments, the user of the first communication device provisioned with the first enhanced PAI is a first user of an account associated with the PAI, and the second communication device provisioned with the second enhanced PAI is associated with a second user of the same account associated with the PAI. In some embodiments, the first and second user may be family members and/or an authorized user of the account.

In some embodiments, the transaction is a first transaction, and the authorization request is a first authorization request. The server computer may receive a second authorization request for a second transaction, the second authorization request comprising an enhanced PAI comprising the PAI and a PSI unique to a payment card. The server computer may then deny the second transaction if the second authorization request comprising the PSI unique to the payment card was initiated by the communication device.

In some embodiments, the enhanced PAI comprising the PSI unique to the communication device and the enhanced PAI comprising a PSI unique to the payment card are both associated with the same user of an account associated with the PAI.

In some embodiments, the PSI unique to the communication device is selected from a first set of PSIs dedicated for use with communication devices, and the PSI unique to the payment card is selected from a second set of PSIs dedicated for use with payment cards.

FIG. 12B is a flowchart illustrating a method 1210 for provisioning a communication device for use with an enhanced PAI. The method 1210 is performed by processing logic that may comprise hardware (circuitry, dedicated logic, etc.), software (such as is run on a general purpose computing system or a dedicated machine), firmware (embedded software), or any combination thereof. In certain embodiments, the method 1210 is performed by the server computer 200 or the payment processing network 140 of FIG. 1A.

The method 1210 may begin when a user performs an enrollment step via a tap or contactless payment application or digital wallet application on his/her communication device. Upon performing the enrollment step, the server computer may receive a request to associate the communication with a PAI (step 1212). The PAI may be associated with an account associated with the user.

After receiving the request to associate the communication with the PAI, the server computer may generate an enhanced PAI comprising the PAI and a PAI sequence identifier (PSI), wherein the PSI is unique to the communication device (step 1214).

After generating the enhanced PAI, the server computer may provision the communication device for use with the enhanced PAI (step 1216).

FIG. 12C is a flowchart illustrating a method 1220 for initiating a transaction using a communication device associated with a user. The method 1220 is performed by processing logic that may comprise hardware (circuitry, dedicated logic, etc.), software (such as is run on a general purpose computing system or a dedicated machine), firmware (embedded software), or any combination thereof. In certain embodiments, the method 1220 is performed by the server computer 200 or the payment processing network 140 of FIG. 1A.

The method 1220 may begin when a user initiates a transaction via a tap or contactless payment application or digital wallet application on his/her communication device. Upon performing the initiating step, the communication device may transmit an authorization request including an enhanced primary account identifier (PAI), the enhanced PAI including a PAI associated with the user and a PAI sequence identifier (PSI), wherein the PSI is unique to the communication device (step 1222).

After transmitting the authorization request including an enhanced primary account identifier, the communication device may receive an authorization response message, wherein the authorization response message is indicative of whether the transaction is authorized based at least in part on the PSI. (step 1224).

It should be appreciated that the specific steps illustrated in FIGS. 12A, 12B, and 12C provide a particular method for facilitating a transaction involving one or more third-parties, according to an embodiment of the present invention. Other sequences of steps may also be performed according to alternative embodiments. For example, alternative embodiments of the present invention may perform the steps outlined above in a different order. Moreover, the individual steps illustrated in FIGS. 12A, 12B, and 12C may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the methods 1200, 1210, and 1220.

It should be understood that the PAI and PSI described herein may include numeral characters, alphanumeric characters, symbols, and/or any combination thereof, and that the PSI may include any number of characters (e.g., 2, 3, 4, or 5 characters). It should also be understood that the PSIs reserved for communication devices may be a range of PSIs (e.g., 51-99), a subset of the possible values of PSIs (e.g., 03, 20, 31, 77, 88 . . . etc.), or a combination thereof.

### VIII. Exemplary Systems

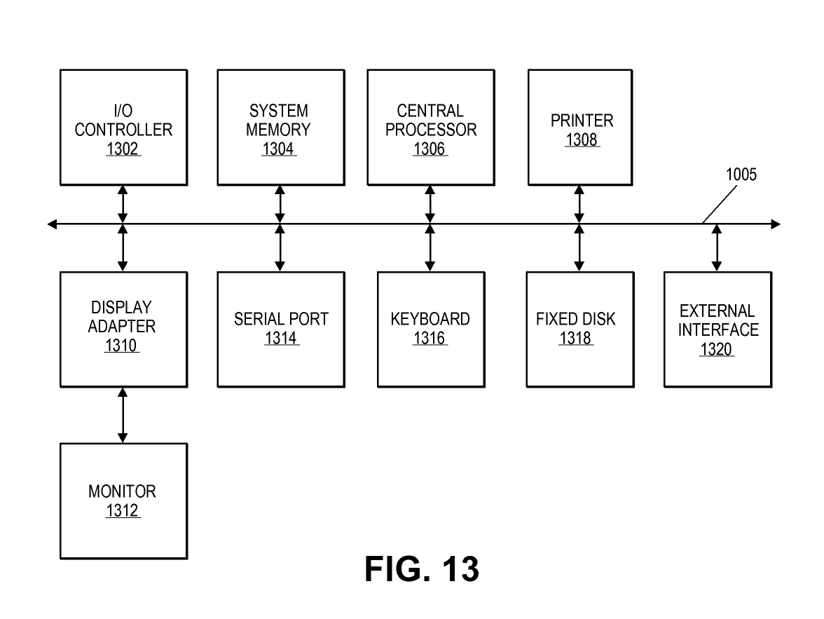

FIG. 13 is a diagram of a computer apparatus 1300, according to an example embodiment. The various participants and elements in the previously described system diagram (e.g., the communication device, payment processing network, acquiring bank, issuing bank, server computer, etc., in FIG. 1A or FIG. 1B) may use any suitable number of subsystems in the computer apparatus to facilitate the methods and/or functions described herein. Examples of such subsystems or components are shown in FIG. 13. The subsystems shown in FIG. 13 are interconnected via a system bus 1305. Additional subsystems such as a printer 1340, keyboard 1370, fixed disk 1380 (or other memory comprising computer-readable media), monitor 1355, which is coupled to display adapter 1350, and others are shown. Peripherals and input/output (I/O) devices (not shown), which couple to I/O controller 1310, can be connected to the computer system by any number of means known in the art, such as serial port 1360. For example, serial port 1360 or external interface 1390 can be used to connect the computer apparatus to a wide area network such as the Internet, a mouse input device, or a scanner. Alternatively, peripherals can be connected wirelessly (e.g., IR, Bluetooth, etc.). The interconnection via system bus allows the central processor 1330 to communicate with each subsystem and to control the execution of instructions from system memory 1320 or the fixed disk 1380, as well as the exchange of information between subsystems. The system memory 1320 and/or the fixed disk 1380 (e.g., hard disk, solid state drive, etc.) may embody a computer-readable medium.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

One or more embodiments of the invention may be combined with one or more other embodiments of the invention without departing from the spirit and scope of the invention.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for facilitating a transaction using a communication device associated with a user, the method comprising:
during the transaction, receiving, at a server computer, an authorization request comprising an enhanced primary account identifier (PAI), the enhanced PAI comprising a PAI associated with the user and a PAI sequence identifier (PSI), wherein the PSI is unique to the communication device;
authorizing the transaction based at least in part on the PSI; and
transmitting at least the PAI to an issuer for authorization of the transaction.

2. The method of claim 1, further comprising:
receiving, at the server computer, a request to associate the communication device with the PAI;
generating, via the server computer, an enhanced PAI comprising the PAI and a PAI sequence identifier (PSI), wherein the PSI is unique to the communication device; and
provisioning, via the server computer, the communication device for use with the enhanced PAI.

3. The method of claim 2, further comprising:
prior to provisioning the communication device for use with the enhanced PAI, verifying an identity of the user of the communication device with the issuer via a secure verification protocol.

4. The method of claim 1, further comprising:
determining, via the server computer, that the authorization request is for a transaction initiated by the communication device based at least in part on the PSI.

5. The method of claim 1, wherein the communication device is a first communication device, the enhanced PAI is a first enhanced PAI, and the PSI is a first PSI, the method further comprising:
generating, via the server computer, a second enhanced PAI comprising the PAI and a second PSI, wherein the second PSI is unique to a second communication device and is different than the first PSI; and
provisioning, via the server computer, the second communication device for use with the second enhanced PAI.

6. The method of claim 5, further comprising:
upon a request from the user of the first communication device, de-provisioning, via the server computer, the first communication device for use with the first enhanced PAI.

7. The method of claim 5, wherein the user of the first communication device provisioned with the first enhanced PAI is a first user of an account associated with the PAI, and the second communication device provisioned with the second enhanced PAI is associated with a second user of the same account associated with the PAI.

8. The method of claim 1, wherein the transaction is a first transaction, and the authorization request is a first authorization request, the method further comprising:
receiving, at the server computer, a second authorization request for a second transaction, the second authorization request comprising an enhanced PAI comprising the PAI and a PSI unique to a payment card; and
denying the second transaction if the second authorization request comprising the PSI unique to the payment card was initiated by the communication device.

9. The method of claim 8, wherein the enhanced PAI comprising the PSI unique to the communication device and the enhanced PAI comprising a PSI unique to the payment card are both associated with the same user of an account associated with the PAI.

10. The method of claim 8, wherein the PSI unique to the communication device is selected from a first set of PSIs dedicated for use with communication devices, and the PSI unique to the payment card is selected from a second set of PSIs dedicated for use with payment cards.

11. A server computer, comprising:
a processor; and
a non-transitory computer-readable storage medium, comprising code executable by the processor for implementing a method for facilitating a transaction using a communication device associated with a user, the method comprising:
during the transaction, receiving, at the server computer, an authorization request comprising an enhanced primary account identifier (PAI), the enhanced PAI comprising a PAI associated with the user and a PAI sequence identifier (PSI), wherein the PSI is unique to the communication device;
authorizing the transaction based at least in part on the PSI; and
transmitting at least the PAI to an issuer for authorization of the transaction.

12. The server computer of claim 11, wherein the method further comprises:
receiving, at the server computer, a request to associate the communication device with the PAI;
generating, via the server computer, an enhanced PAI comprising the PAI and a PAI sequence identifier (PSI), wherein the PSI is unique to the communication device; and
provisioning, via the server computer, the communication device for use with the enhanced PAI.

13. The server computer of claim 12, wherein the method further comprises:
prior to provisioning the communication device for use with the enhanced PAI, verifying an identity of the user of the communication device with the issuer via a secure verification protocol.

14. The server computer of claim 11, wherein the method further comprises:
determining, via the server computer, that the authorization request is for a transaction initiated by the communication device based at least in part on the PSI.

15. The server computer of claim 11, wherein the communication device is a first communication device, the enhanced PAI is a first enhanced PAI, and the PSI is a first PSI, the method further comprising:
generating, via the server computer, a second enhanced PAI comprising the PAI and a second PSI, wherein the second PSI is unique to a second communication device and is different than the first PSI; and
provisioning, via the server computer, the second communication device for use with the second enhanced PAI.

16. The server computer of claim 15, wherein the method further comprises:
upon a request from the user of the first communication device, de-provisioning, via the server computer, the first communication device for use with the first enhanced PAI.

17. The server computer of claim 15, wherein the user of the first communication device provisioned with the first enhanced PAI is a first user of an account associated with the PAI, and the second communication device provisioned with the second enhanced PAI is associated with a second user of the same account associated with the PAI.

18. The server computer of claim 11, wherein the transaction is a first transaction, and the authorization request is a first authorization request, the method further comprising:
receiving, at the server computer, a second authorization request for a second transaction, the second authorization request comprising an enhanced PAI comprising the PAI and a PSI unique to a payment card; and
denying the second transaction if the second authorization request comprising the PSI unique to the payment card was initiated by the communication device.

19. The server computer of claim 18, wherein the enhanced PAI comprising the PSI unique to the communication device and the enhanced PAI comprising a PSI unique to the payment card are both associated with the same user of an account associated with the PAI.

20. The server computer of claim 18, wherein the PSI unique to the communication device is selected from a first set of PSIs dedicated for use with communication devices, and the PSI unique to the payment card is selected from a second set of PSIs dedicated for use with payment cards.

21. A method for facilitating a transaction, the method comprising:
during the transaction, transmitting, via a communication device associated with a user, an authorization request comprising an enhanced primary account identifier (PAI), the enhanced PAI comprising a PAI associated with the user and a PAI sequence identifier (PSI), wherein the PSI is unique to the communication device; and
receiving, via the communication device, an authorization response message, wherein the authorization response message is indicative of whether the transaction is authorized based at least in part on the PSI.
